(19) United States
(12) Patent Application Publication
(10) Pub. No.: US 2004/0239016 A1
(43) Pub. Date: Dec. 2, 2004

(54) Multi-hole, multi-edge control phate for linear sliding gate

(76) Inventors: Patrick Dana King, Rantoul, IL (US); Douglas Howard Ross, Birmingham, AL (US)

Correspondence Address: Vesuvius USA Corporation, 27 Noblestown Road, Carnegie, PA, 15106-1632, US

(21) Appl. No.: 10/494,694

(22) PCT Filed: Nov. 12, 2002
(86) PCT No.: PCT/US02/36120

Related U.S. Application Data
(60) Provisional application No. 60/338,159, filed on Nov. 13, 2001.

(51) Int. Cl. B67D 3/00

(52) U.S. Cl. 266/236

(57) ABSTRACT

An assembly of slide gate valve plates are described for use in the casting of molten metal. The assembly includes a fixed plate and a sliding plate having a plurality of bores. The extremes of stroke available to the sliding plate produce at least two cutting edges and an emergency shut-off position that is independent of transducers, sensors, or operator judgment. The plate may include oval-shaped bores for increased shut-off margin or offset bores for improved flow of the molten metal through the pouring channel defined by the alignment of the fixed bore with a sliding bore.

### FIELD OF THE INVENTION

The invention relates to the continuous casting of molten metal. More specifically, the invention relates to an article for controlling the flow liquid metal during continuous casting.

### BACKGROUND OF THE INVENTION

Slide gate valves and their associated refractories are used for controlling the flow of molten metal from metallurgical vessels, including furnaces, ladles and tundishes. Slide gate valves are set on the outer surface and on the side or bottom of the vessel. The valve comprises at least a first refractory plate slidingly engaging a second refractory plate. The plates typically include a stationary plate and a sliding plate. Each plate includes at least one bore. Placing the bores in alignment defines a pouring channel and permits the liquid metal to flow from the vessel and through the valve. Sliding the plates relative to each other moves the bores increasingly out of alignment, thereby slowing the flow of molten metal, until the pouring channel is closed.

Sliding gate valves include rotary and linear types. The sliding plate in rotary valves rotates about the fixed plate. The sliding plate in a linear valve translates relative to the fixed plate.

A refractory plate for use in rotary valves may include more than one bore. The sliding plate cooperates with a stationary plate and rotates about a central axis until a bore in the sliding plate fluidly communicates with a bore in the stationary plate. Disadvantageously, rotary valves have no emergency shut-off position, that is, in an emergency, an operator must adjust the disposition of the rotary plates so that the bores no longer line up. Rotary valves must rely on positional feedback, such as, an electrical transducer or mechanical marker or an operator's visual verification, to ensure positive shut-off.

In contrast, linear valves can have a built-in emergency shut-off position independent of positional feedback or operator verification. Linear valves may be designed so that moving the sliding plate completely to one side forces the sliding plate against a physical stop. At this extreme, the bores in the plates are not aligned and positive shut-off is achieved. Other linear valves have incorporated plates comprising two bores, where a bore is positioned at or near the extreme stroke limits of the sliding plate, that is, bores at either end of the sliding plate. Shut-off of the flow of liquid metal in such multi-bore plates occurs only by adjusting the plates so that the center of the sliding plate aligns with the bore of the fixed plate. Like rotary valves, multi-bore linear valves have no positive emergency shut-off.

Both rotary and linear slide gate valve refractories may also comprise cutting edges at least partially surrounding bores in the plates. Deposits can form at the interface of the sliding and fixed plates. These deposits include solidified metal and oxides that span the interface of the two plates. The cutting edges sever the deposits and permit movement of the plates. For example, U.S. Pat. No. 5,348,202 describes a cutting edge comprising a hard ceramic material around the pouring channel.

Cutting edges can deteriorate with use or time. The flow of liquid metal can erode the edge. Alternatively, breaking through deposits can dull or break the edge. Deposits, such as alumina, can also clog the bore. Erosion or wear on the edges could permit leakage of molten metal between the plates. Clogging can prevent casting. Worn bores must, therefore, be abandoned when they deteriorate beyond a minimum specification. Rotary plates may comprise more than one bore, which permits extended use of a single plate simply be rotating the plates to create a new pouring channel with the second set of bores.

Linear plates typically do not have a second set of bores, so linear plates with worn bores must be changed. Multiple bores with multiple cutting edges would overcome this problem, but would normally require longer plates, larger slide gate mechanisms, and greater cost. Methods to overcome this single bore limitation in linear plates include, U.S. Pat. No. 4,890,665, in which both the near and far edges of the bore in the linear plates are used as cutting edges.

A need persists for a slide gate valve having multiple bores with multiple edge control while incorporating a positive emergency shut-off.

### SUMMARY OF THE INVENTION

The invention describes an article for use with linear sliding gate valves in the casting of molten metal. The articles include a fixed plate slidingly engaging a sliding plate. The sliding plate includes a plurality of bores through which the molten metal may flow. Aligning the bores defines a pouring channel for the molten metal. Offsetting the alignment of the bores throttles the flow of molten metal.

In a first embodiment, the motion of the sliding plate enables the fixed bore to extend beyond the outer edges of the sliding plate bores. Advantageously, this provides the plate assembly with either (i) at least two cutting edges and an emergency stop position, or (ii) more than two cutting edges. The positive location of the emergency stop position requires no transducers or operator judgment. An alternative embodiment provides a stop position between the bores of the plate.

Other embodiments include elliptical or oval bores. Elliptical bores can increase the size of the stop positions while maintaining the same flow rate of molten metal. Offset bores promote a straighter liquid metal flow path and a more symmetrical and less turbulent discharge, thereby reducing the potential for clogging and erosion of the gate components affect the flow of molten metal though the valve.

A plate may also include a tapered outer edge. Conveniently, the tapered edge facilitates clamping of the plate within the valve assembly.

### BRIEF DESCRIPTION OF THE DRAWINGS

FIG. 1 is a top plan view of a slide gate valve plate of the prior art;

FIG. 2 is a top plan view of the slide gate valve plate of FIG. 1 with enlarged bores;

FIG. 3 is a top plan view of the slide gate valve plate of FIG. 1 with oval bores;

FIG. 4 is a top plan view of an assembly comprising the slide gate valve plate and a clamp ring of the present invention;

FIG. 5 is a longitudinal sectional view of the assembly of FIG. 4 along the 5-5 axis;

FIG. 6 is a longitudinal sectional view of the assembly of FIG. 4 along the 6-6 axis;

FIG. 7 is a top plan view of the assembly of FIG. 4 showing an offset bore.

### DETAILED DESCRIPTION OF THE INVENTION

A linear sliding gate valve comprises at least two refractory plates capable of motion relative to each other. Typically, motion is restricted to only one plate, that is, the sliding plate. The remaining plates are fixed. The sliding plate moves linearly relative to the fixed plate. The plates are often secured in the valve with a clamp and a frame.

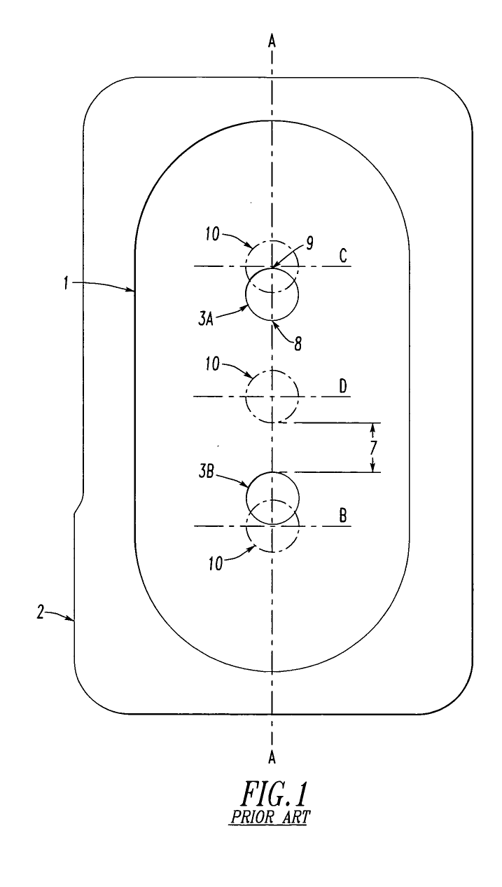

FIG. 1 shows a portion of a prior art, linear, multi-bore sliding gate valve comprising a refractory sliding plate 1 surrounded by a frame 2. The frame 2 is adapted to hold the plate 1 in the valve and translate the plate along the axis of motion A-A. The sliding plate 1 includes two bores (3A and 3B). The fixed plate (not shown) includes a single bore represented by the dashed circle.

In a first relative position B of the fixed and sliding plates, the sliding plate is at an extreme position of travel within the valve, that is, at an extreme of stroke. The bore 10 of the fixed plate extends along the direction of motion beyond the bore 3A of the sliding plate. In a second relative position C, the sliding plate is at an opposite extreme of travel. The bore 10 of the fixed plate extends along the direction of motion beyond the bore 3B of the sliding plate. A third relative position D, centers the bore 10 of the fixed plate between the bores (3A and 3B) of the sliding plate. The shut-off margin 7 is the distance between the edges of the sliding bore 3 and the fixed bore 10.

Moving the plates so that the fixed plate bore is in the shut-off area requires, for example, transducers or operator control to ensure shut-off. No positive mechanical means places the fixed bore in the shut-off area. Furthermore, limitations on the extremes of stroke provide prior art slide gate valves with only two cutting edges. The edges are on the inside edges 8 of the sliding plate bores 3. Prior art multi-bore valves included at most two cutting edges and a shut-off area that depends on operator control.

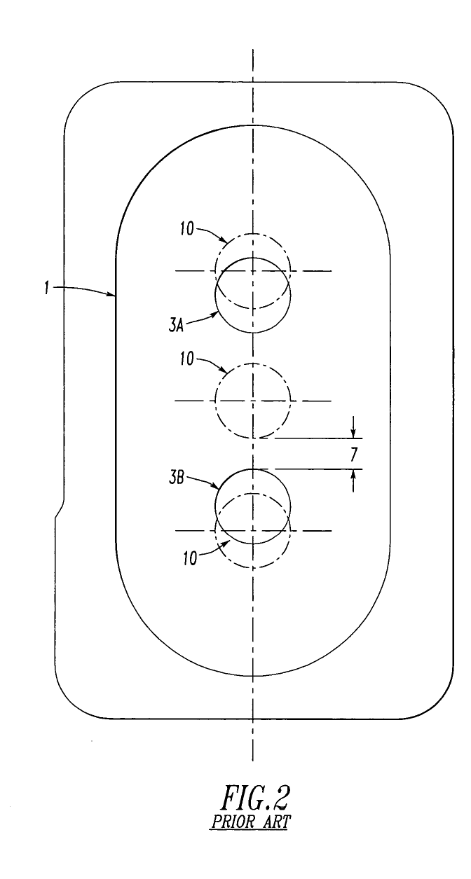

FIG. 2 shows a prior art refractory plate 1 similar to that of FIG. 1, except the fixed plate bore 10 and the sliding plate bores 3 are enlarged. The shut-off margin 7 decreases as the size of the bores 3 increases. Also, the turn-down ratio, that is, the potential reduction in flow volume from a fully opened position, decreases with the size of the bore. Consequently, as the bore increase, the shut-off area decreases and the degree of control over flow decreases.

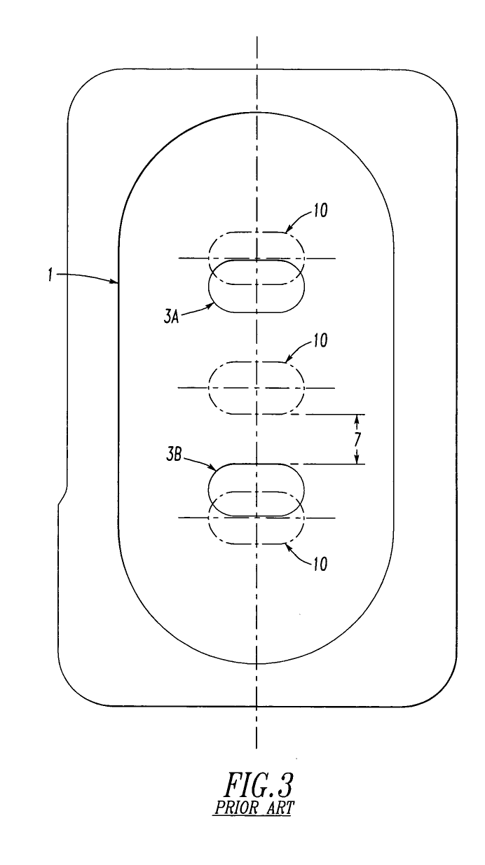

FIG. 3 shows a variation on bore shape that attempts to reduce the reduction in shut-off margin and turn-down ratio. The sliding plate bores (3A and 3B) and the fixed plate bore 10 are oval-shaped. The shut-off margin 7 is increased over that of a circular bore. Also, the turn-down ratio is increased over a circular bore having the same area. This design does not solve the two major deficiencies of the prior art, namely, providing for more than two cutting edges and a positive stop for emergency shut-offs.

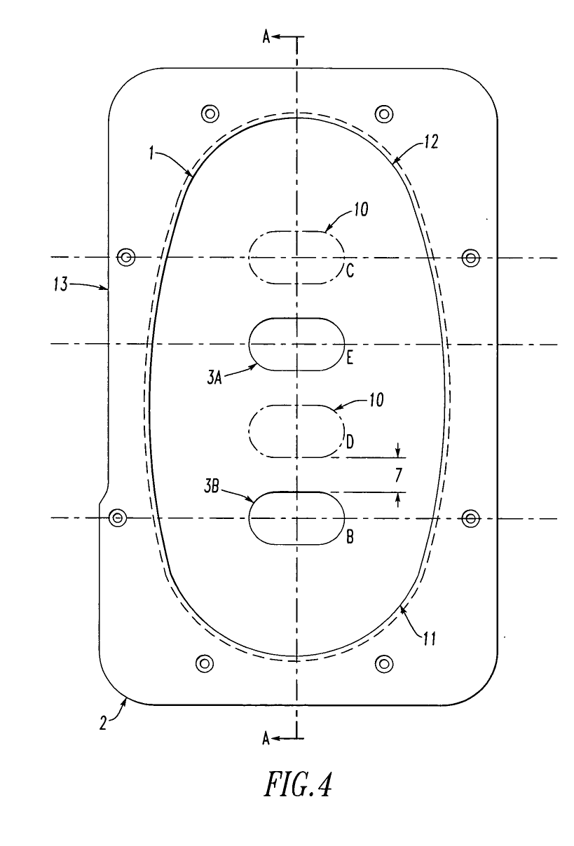

FIG. 4 shows a plate of the present invention. A refractory sliding plate 1 surrounded by a frame 2. The frame 2 is adapted to hold the plate 1 in the valve and translate the plate along the axis of motion A-A. The sliding plate 1 includes two sliding bores (3A and 3B). The fixed plate (not shown) includes a single bore 10 represented by the dashed circles. The sliding and fixed bores are shown as oval-shaped, but may be circular or any other convenient shape. The use of oval-shaped bores permits a greater shut-off margin 7 between the shut-off position D and positions B and E. The plate is typically asymmetric having a large end 11 and a small end 12. Asymmetry reduces the chance of misinsertion in the frame 2, but a symmetrical plate is permissible. Alternatively, frame or plate may include a notch 13 that prevents reversal of the plate in the valve.

The bores have four working positions. At a first extreme stroke B, the sliding plate bore 3 and the fixed plate bore 10 at least partially align to create a pouring channel. FIG. 4 shows the bores as completely aligning. At a second extreme stroke position C, the sliding plate bore 3 is not aligned with the fixed plate bore 10. This represents an emergency stop position. In the event of an emergency, an operator can push the sliding plate to the second extreme position C, and the valve will be positively closed. The extreme stroke position C is a mechanical limitation of the valve and does not depend on transducers or operator precision. Failure of a transducer or positional feedback sensor has no effect on the emergency shut-off. Between extremes B and C, there exist a second shut-off position D and a second alignment of the bores E.

The embodiment of FIG. 4, therefore, describes a configuration in which the valve includes a shut-off position D, an emergency shut-off position C, and two fully aligned positions (B and C) at which the turn-down ratio is 1. Additionally, the range of motion of the sliding plate permits this configuration to have three cutting edges, that is, one at position B and two at position C because the valve may be throttled on either side of position C. Alternative embodiments could include more than two bores in the sliding plate, a first extreme position where the bores do not completely align, or a second extreme position where the bores align to some extend. Such modifications would change the number of cutting edges or the presence of an emergency shut-off position. One skilled in the art could readily design a number variations based on the above disclosure.

FIG. 5 shows a longitudinal section along the A-A axis of one embodiment of FIG. 4. The sliding plate includes an upstream face 14, a downstream face 15, and two bores (3A and 3B) situated asymmetrically in the faces of the plate. Inserts 20 define the bores 3. The inserts typically comprise a hard, erosion-resistant material such as zirconia. The outer edge of the plate includes an upstream tapered edge 16A and a downstream tapered edge 16B. An upper clamp ring 18 and a lower clamp ring 19 mate with upstream and downstream edges, respectively. The clamp rings must be thinner than their respective edges so as to define an operating clearance 21; otherwise, the rings may contact adjacent plates and prevent proper functioning of the valve. Preferably, the upstream and downstream edges define two, non-equal angles (17A and 17B). Non-equal angles reduce the likelihood that the plate would be misinserted.

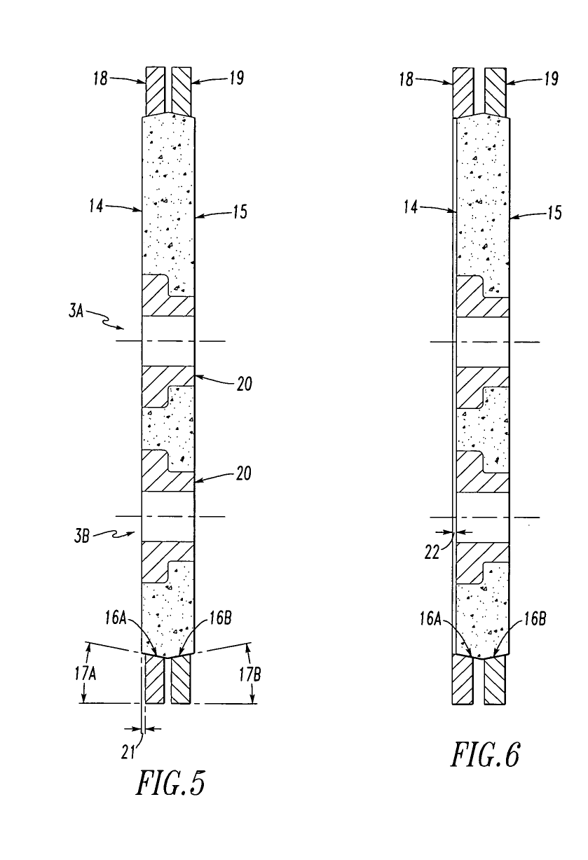

FIG. 6 depicts misinsertion of the plate relative to the clamps. The downstream edge 16B is mated to the upstream clamp 18, and the upstream edge 16B is mated to the downstream clamp 19. This situation causes the upstream clamp 18 to protrude beyond the plate by an interference distance 22. Interference prevents proper assembly and closure of the sliding gate valve. Improper assembly could be disastrous because the normal emergency shut-off position is now a wide-open position. Additionally, asymmetries in the plate, that is, placement of the bores relative to a large end or small end, could accelerate erosion and permit degradation of the plate beyond its edges.

The present invention also finds use in offset bore technology, as described in U.S. patent application Ser. No. 10/221516, the description of which is incorporated herein by reference. Offset bores are described as producing a less tortuous and more symmetrical flow path when the slide gate valve is partially open, while providing a relatively straight downward pour channel allowing full flow when the gate is fully open. The offset bore is designed to throttle in a single direction.

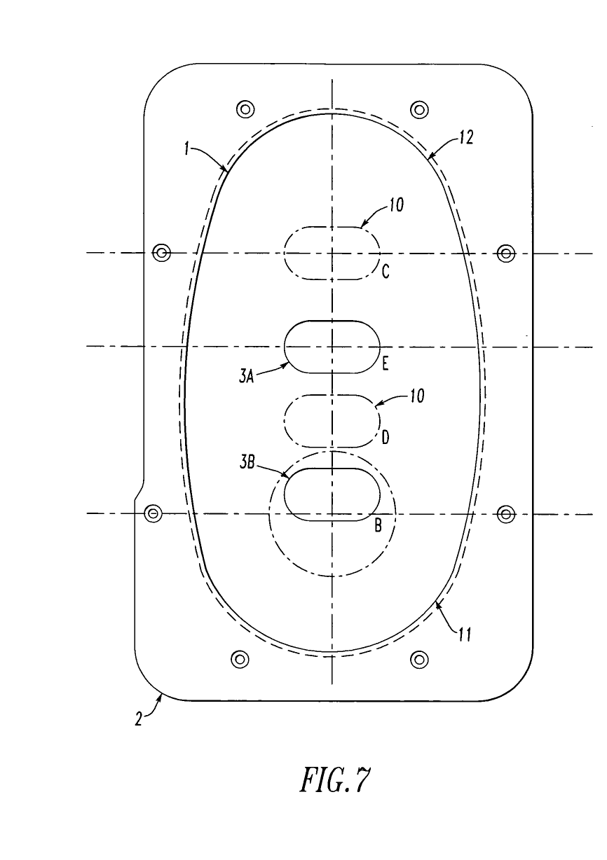

The method of using the multi-bore sliding gate valve is described with reference to FIG. 7. A sliding plate 1 includes oval-shaped bores (3A and 3B). The fixed plate bore 10 is shown as a dashed oval. The sliding bore 3B and fixed bore 10 first align at position B. Throttling occurs from position B through shut-off position D to position E. Emergency shut-off position C position remains available for if neded. Advantageously and unlike prior art, the present invention permits full throttling of plates, which incorporate offset bore technology.

Although the present invention has been described in relation to particular embodiments thereof, many other variations and modifications and other uses will become apparent to those skilled in the art. It is preferred, therefore, that the present invention be limited not by the specific disclosure herein.

1-11. (canceled).

12. An assembly of refractory plates for use in a linear slide gate valve adapted to control a flow of liquid metal from a metallurgical vessel, comprising a fixed refractory plate having an inner surface defining a fixed bore, a sliding refractory plate having a plurality of inner surfaces defining a plurality of sliding bores, the fixed plate slidingly engaging the sliding plate whereby alignment of the fixed bore with the sliding bore defines a pouring channel for discharging the liquid metal from the metallurgical vessel, and the pouring channel includes two cutting edges and at least one element selected from the group consisting of an emergency shut-off area at a positive stop position and a third cutting edge.

13. The assembly of refractory plates of claim 12, wherein the assembly includes a first extreme position at which one sliding bore aligns with the fixed bore, and a second extreme position at which the fixed bore does not align with the sliding bores, thereby defining an emergency shut-off position.

14. The assembly of refractory plates of claim 12, wherein the assembly comprises a second shut-off area between two sliding bores of the sliding plate.

15. The assembly of refractory plates of claim 12, wherein the bores are oval-shaped.

16. The assembly of refractory plates of claim 12, wherein the bores comprise offset bores.

17. The assembly of refractory plates of claim 12, wherein at least one plate includes an anti-reversal notch.

18. The assembly of refractory plates of claim 12, wherein at least one plate includes a tapered outer edge adapted to cooperate with a mating clamp ring, whereby the plate is secured in the slide gate valve.

19. The assembly of refractory plates of claim 18, wherein the outer edge comprises two tapered faces adapted to cooperate with two mating clamp rings.

20. The assembly of refractory plates of claim 19, wherein the sliding plate includes an upstream face and the tapered faces intersect a plane formed by the upstream face at non-equal angles, whereby mismating the clamp rings and the tapered faces will prevent misinsertion of the sliding plate.

21. The assembly of refractory plates of claim 12, wherein the sliding plate comprises a large end and a small end.

22. The assembly of refractory plates of claim 21, wherein the sliding bores are asymmetrically placed towards the large end of the sliding plate.
